(19) United States
(12) Patent Application Publication
(10) Pub. No.: US 2002/0175945 A1
(43) Pub. Date: Nov. 28, 2002

(54) Method and apparatus for accessing information through a user friendly interface

(76) Inventors: Jean Paul Van Hissenhoven, Bogota (CO); Jorge Di Terlizzi, Bogota (CO)

Correspondence Address: GOTTLIEB RACKMAN & REISMAN PC, 270 MADISON AVENUE, 8TH FLOOR, NEW YORK, NY, 100160601

(21) Appl. No.: 09/809,669

(22) Filed: Mar. 15, 2001

(51) Int. Cl. G06F 3/00

(52) U.S. Cl. 345/775

(57) ABSTRACT

A system for accessing information either from a local data base or over the Internet includes a data access device adapted to display an image of a friendly environment, the image including image elements which suggest to a user certain types of information of interest. The image further includes display areas for displaying messages identifying the information associated with certain image elements. When an image element is selected, a second image is shown by the data access device. This second image includes indicia of several information categories. The indicia can be selected causing a web browser to download and display the corresponding information. This information may be generic or may be user-specific.

### BACKGROUND OF THE INVENTION

1. Field of Invention

This invention pertains to a method and apparatus for accessing information over the Internet and more particularly to a system having a user friendly interface. The interface allows a user to gain access to information available from various web sites as well as personalized information.

2. Description of the Prior Art

Over the last couple of years, the Internet became a major source of information and entertainment for a large portion of the population. With only a home or personal computer and access to a telephone line, cable connection or wireless connection, a person can access through the Internet web sites from literally all over the world. Moreover this information covers virtually every aspect of human endeavor, including business, finances, sports, entertainment, games and so on.

Initially, accessing the Internet was fairly difficult, even for individuals with a computer and Internet access means. The Internet accessing software was in its infancy and using it was a challenge even for professional and serious computer-literate individuals. More recently, Internet browsers became available which were much easier to use by every one. Moreover, some of these browsers included separate components or worked with off the shelf components to provide many different Internet-related functions, such as searching and displaying web sites, viewing newsgroups and exchanging e-mail messages. As a result a much larger percentage of the population can now enjoy the advantages offered by the Internet.

However, a significant number of people still do not access the Internet for several reasons. One reason may be that they are intimated by computers in general. A second reason may be that even if they can perform some basic operations on a computer, accessing the Internet may be too intimidating. This problem is further complicated by the large number of content suppliers. These suppliers bombard Internet users from all the corners of the world using any and all languages, to a point were it is very difficult and confusing for a user to determine which information source to chose or how to find an information provider that is trustworthy, reliable and meets his specific requirement.

A third reason may be that the presently available browsers and other information portals are too confusing to use. Moreover, most directories and other information portals are incomplete or inaccurate. It has been estimated that at any given time, web browsers can locate only a small fraction of the relevant web sites, and that of these ‘hits’ many are inaccurate and non-functional.

In general it may be stated that many individuals have not tried accessing the Internet because the present interfacing means are unfriendly. Moreover, present interface means appear to be remote and foreign from the environments that most individuals encounter during their normal, daily activities.

It has been recognized in the industry that there is a need for a metamediary, which is a trusted third party that can provide a single point contact between the Internet users and the many content suppliers. Such an entity could focus on a broad, yet qualified selection of information, services and other activities affecting the lives of individual Internet users. Moreover such an entity is much more effective and attractive to individuals who shy away from existing Internet interfaces if it can provide a simple, and friendly Internet interface.

### OBJECTIVES AND ADVANTAGES OF THE INVENTION

In view of these problems associated with standard data access means, it is an objective of the present invention to provide a system in which a user friendly graphic interface is provided for retrieving and storing information.

A further objective is to provide a user friendly data access system and method which mimics or simulates standard, non-computer based environments formed of objects that are familiar to many potential users of the system.

A further objective is to provide a graphic Internet interfacing means which can be integrated seamlessly and transparently with standard Internet browsers.

A further objective is to provide a graphic interface that can be used easily and intuitively with little or no instructions.

Yet another objective is to provide an Internet interface which is integrally combined for registered users with a personal digital assistant.

Other objectives and advantages of the invention shall become apparent from the following description. Briefly, a system adapted to provide data exchange or access for a user, constructed in accordance with this invention includes a data access device having a pointing device; and a screen coupled to said data access device and arranged to display an image of a user familiar environment, said user familiar environment being formed of a plurality of objects, each object being suggestive of a category of information. For this purpose, the image has image elements corresponding to the suggestive objects. The data access device is adapted to obtain information corresponding to one of said objects when said pointing device points to the image element corresponding said one object. Preferably, the image includes a display area and the data access device is adapted to show a message in said display area, which message may identify, for example, the information associated with a particular image element. Some of the images may be moving images which are set in motion when the respective image element is selected through the pointing device. The message may become visible when the respective image element is selected.

In a preferred embodiment, the system also includes an Internet connection and the data access device is coupled to the Internet connection and is adapted to provide data exchange through said Internet connection with other locations.

In one embodiment, the system in response to a command selection, said data access device is adapted to generate commands to control remote devices.

### BRIEF DESCRIPTION OF THE DRAWINGS

FIG. 1 depicts an image of a familiar environment such as a home office formed of images representing various data access elements;

FIG. 2 shows a block diagram of a data access device such as a PC used to generate the image of FIG. 1;

FIG. 3 shows a flow chart of the operation of the information access device of FIG. 2;

FIGS. 4A, 4B and 4C show a moving element of the image of FIG. 1;

FIG. 5 shows second screen for accessing information selected using the image of FIG. 1;

FIG. 6 shows another screen for accessing other information selected using the image of FIG. 1;

FIG. 7 shows a block diagram of a data server used in conjunction with the information accessing device of FIG. 2 to deliver information;

FIG. 8 shows an image of a kitchen with its own data access images.

### DETAILED DESCRIPTION OF THE INVENTION

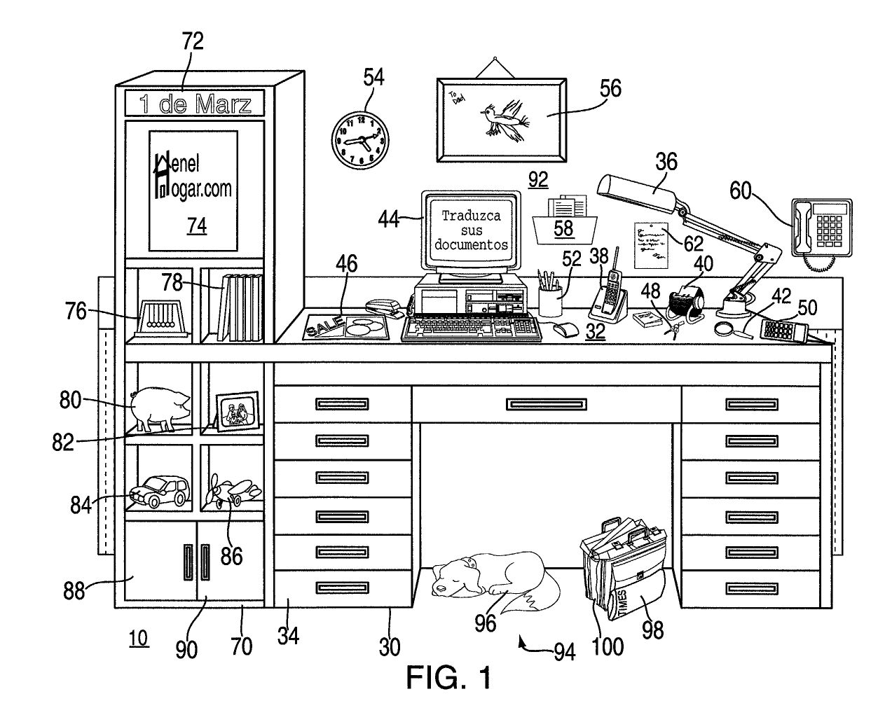

As previously mentioned, the present invention pertains to a data access interface that is very easy to use and requires minimal training. The data access interface is illustrated by the diagram of FIG. 1 which shows an image 10 appearing on the screen of a typical data access device used to store and retrieve information either locally or through the Internet. The image 10 illustrates a familiar environment such as a home office with a desk 32 and a hutch 70. For instance, the data access device may be a desktop PC, a portable PC, cellular telephone, a PDA, a device dedicated for providing Internet access, such as WebTV, an Internet appliance and so on. This image 10 may be displayed for instance when a user access his web browser, or when he turns on the data access device on.

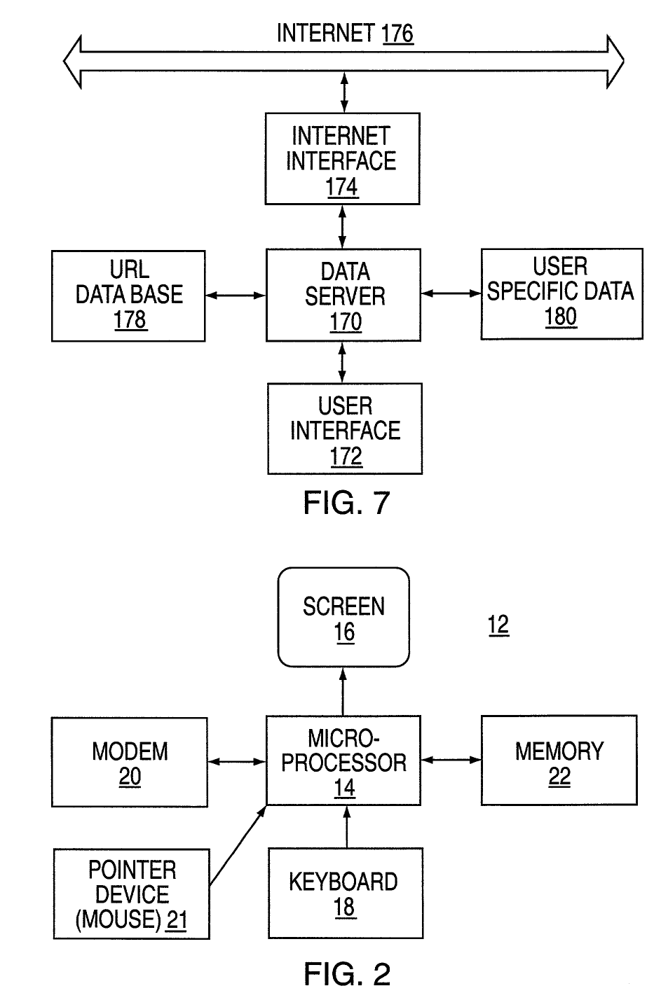

FIG. 2 shows the elements of a typical Data access device 12. Device 12 normally includes a microprocessor 14, a screen 16 used inter alia to show the image 10, a keyboard 18 and a connection device for connecting to the Internet, such as a modem 20. Device 12 may also include a local memory 22 which may be used to store user specific information and software for the operation of the device 12, for generating and running the Internet interface and for running the Internet browser associated with the Internet interface. The device 12 is further equipped with a pointer controller 21 operated by the user to select image elements on image 10 as described more fully below. The pointer controller 21 may be a mouse, a touch screen, or other similar device. While device 21 is shown as a separate element, it may be incorporated into the keyboard 18.

Importantly, the image 10 of FIG. 1 depicts a common environment familiar to users and it includes one or more common objects which are normally found in everyday life. The image 10 includes image elements corresponding to these objects. Preferably the objects shown image 10 are related to or suggest to the user an act of storing and retrieving information, data, documents, etc. For example, in FIG. 1, the image 10 shows the desk 30 with a top 32 and a plurality of drawers 34. On the desk 30 there are shown several additional objects such as a lamp 36, a cordless telephone 38, a calendar 40, a magnifying glass 42, a PC 44, classified ads 46, a set of keys 48, a cellular telephone 50, and some pencils 52.

On a wall behind the desk 30 there is shown a camera 54, a painting 56, a mail storage shelf 58, a wall-mounted telephone 60, and some notes 62.

Adjacent to the desk is a hutch 70. Hutch 70 is shown with a display area 72 (showing information, such as the present date), and several shelves holding a TV set 74 (which has its own ‘screen’ that may be used as a display area as well), a mobile 76, books 78, a piggy bank 80, a picture frame 82, a model or toy car 84, an airplane 86 and a pair of closed doors 88 and 90. In between frame 56 and hutch 72 there is a portion of blank wall 92 which may be used as another display are to show messages to the user. A third display area 94 is provided in front of the desk 30.

Underneath the desk 30 there are other image elements corresponding to a dog 96, a newspaper 98 and a briefcase 100. Some of the picture elements of image 10 may be moving, change color or have other dynamic features to enhance the esthetic aspect of the image 10. For example the balls of the mobile 76 may be moving like a pendulum.

Thus the image 10 illustrates an environment of various common, every day objects, arrange to provide a user with a very friendly, almost low tech ambiance.

As with all images generated by Internet access devices, superimposed on image 10 is a pointer P which may be moved across the screen and which is provided to allow the user to obtain documents, information or other content. The position of the pointer P is controlled by the pointer control 21.

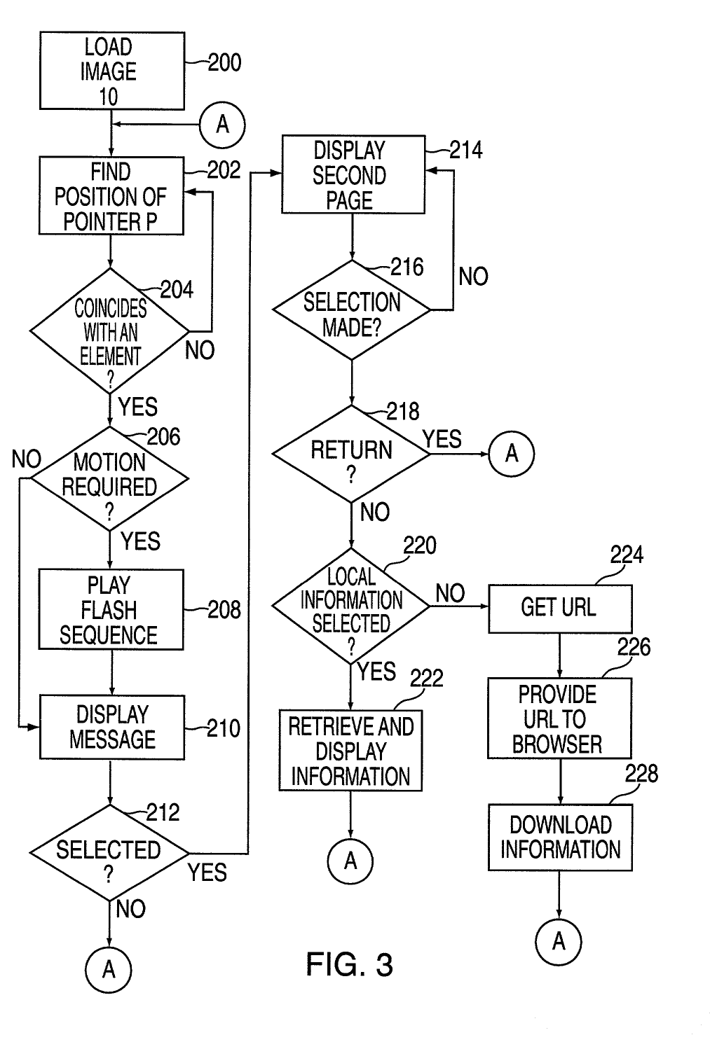

The operation of the device 12 is now described in conjunction with the flow chart of FIG. 3. Starting in step 200, the image 10 is loaded and displayed on screen 16. Once the image 10 is loaded, some automatic functions may be performed without any user input. These automatic functions may be associated with esthetic images or with generic information. For example, the mobile image 76 may be a moving image which is updated at regular intervals to cause its balls to move. Display area 72 may be used to show the current date.

Initially, as can be seen in FIG. 1, no web addresses, Internet links, or other similar connections to other web pages or local data is seen on the image to provide a low-tech friendly esthetic ambiance. As the pointer P is moved across the image, if it is superimposed over a specific image element, one of two actions occur. For some of the image elements, a message appears in one of the display areas. Since several display areas are provided on image 10, preferably a display area for the message is selected which is closest to the respective image element. For example, for elements on the desk top 32 or the wall, such as elements 36, 38, 40 or 56, 58, 60 the display area 92 can be used. For elements on the hutch 70, such as the mobile 76, books 78, airplane 86, etc., the display area 74 (the TV ‘screen’) may be used. For elements under the desk 30, such as the dog 96, or briefcase 100, the display area 94 may be used.

The messages that appear in the respective display area identify the purpose of the respective image elements, i.e. the information that can be accessed if that particular image element is selected. In one sense, the image elements act as data portals so that when they are activated, a user can access data, store data or perform other functions. For this purpose, the image elements act as icons because they bear some suggestive relationship to the data that can be accessed therethrough. The following list is illustrative of some of the data that can be obtained through these image elements:

| | |
|---|---|
| Element | Data (Including local information or Internet |
| | connection or site) |
| Wireless telephone 38 | Connection Internet telephone, chat sites, |
| | newsgroups |
| Calendar 40 | Appointment book, contact information |
| Pencils 52 | Subscriptions to magazines, periodicals, |
| | newspapers, webpages. |
| Magnifying glass 42 | Internet search engines |
| Mobile 76 | Entertainment |
| Books 78 | Education related reference sources |
| Model car 84 | Information on cars owned by user, and other |
| | automotive information |
| Model airplane 86 | Travel information |
| Dog 96 | Information on the house pet, and related |
| | animal websites |

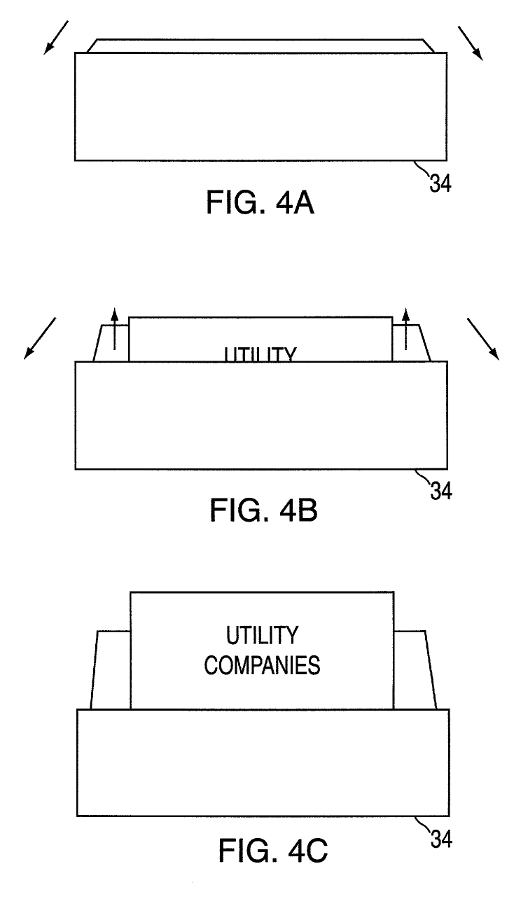

These are just some examples of how image elements may act as icons to suggest data. In addition to these icon-type image elements, the image 10 may also include several generic-type image elements such as drawers 34 and doors 88 and 90. When the pointer P passes over these image elements, a display window opens up with a message indicating the data to be accessed or associated with the respective image elements. Preferably the window opens up slowly to simulate a motion for the respective image element, as shown in FIGS. 4A-4C for a typical drawer 34. In FIG. 4A drawer 34 is shown as being slightly opened (the remainder of the desk 30 has been omitted for the sake of clarity). In FIG. 4B, the drawer 34 is shown in a more opened position, and a window W simulating a sheet of paper starts rising out of the drawer 34. In FIG. 4C the drawer 34 is shown fully opened and a larger portion of the window is seen with the message ‘PUBLIC UTILITY COMPANIES’. The doors 88 and 90 can be moved in the same manner to show messages ‘hidden’ behind them. As these image elements ‘move’ the data access device 12 may also generate appropriate sounds. So, for example, when a drawer is opened and closed, a rasping sound may be heard simulating the opening or closing of a real drawer.

Each of the drawers 34 and doors 88, 90 can be assigned to a different data, function or subject matter. Some typical categories of information that may be accessed through drawers include (but are not limited to);

Home delivery of products such fast foods and other food stuff, drugs, dry cleaning;

Health care including hospitals, doctors, pharmacies, HMOs, health insurance, nutrition, exercise, chat rooms;

Shopping including supermarkets, department stores, specialty and retail stores, Internet or electronic retailers;

Repair and maintenance of household appliances, carpet cleaning, painting, automotive repair, tailoring, shoe repair;

Money and other financial matters including banking, trading of commodities, stock market quotes, credit card information, credit ratings, pension funds, investment advice, insurance;

Taxes including real estate taxes, inheritance, personal property taxes, income taxes, forms for taxes;

Applications and registrations for passports, visas, motor vehicle registrations, social security;

Family including adoption and welfare agencies;

Legal services including law firms, courts, on-line legal documents;

Emergency services including emergencies telephone numbers, first aid.

Public service and utility companies.

The information that can be accessed through the drawers or other image elements can be user-specific information that has been previously stored on the device 12, or in a data bank at a remote location (as discussed in more detail below) and accessed via the Internet, or it can be generic information found on web pages from content providers.

Preferably the motions of the image elements described above are created using Flash or similar techniques that can be used to generate animated image elements on the web.

Referring back to FIG. 3, in step 202 the position of pointer P with respect to image 10 is determined. In step 204 a decision is made as to whether the current pointer position requires an action, i.e., whether the pointer is positioned over or coincides with one of the image elements that can be used to access data or provide other functions. If such a pointer position is detected then in step 206 the nature of the image element is determined, i.e., whether simulated motion is required or not. If motion is required then in step 208 the proper sequence is played (as discussed above in relation to FIGS. 4A-4C). After the sequence is played, the appropriate message is shown on window W in step 210. Alternatively, if no sequence is required than in step 210 an appropriate message is shown in one of the display areas, 74, 92 or 94.

Next, in step 212 a determination is made as to whether the image element has been selected by the user. The actual selection step is dependent on the Internet access device 12 being utilized. For a standard or laptop PC, the selection may be made by activating a button on the mouse 21.

If the image element is not selected, the process returns to step 202.

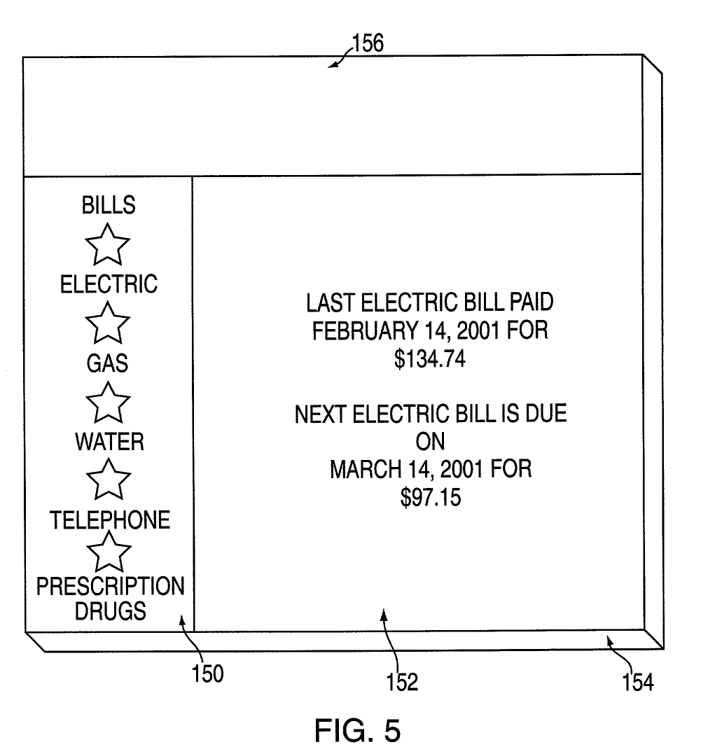

If the image element is selected in step 212, then in step 214 a page is displayed instead of image 10. Preferably a separate page is displayed for each of the image element so that each such page can be customized. In FIG. 1 the image element 80 is a piggy bank represents bills incurred by the user. If in step 212, image element 80 is selected then in step 214 a second page is displayed, which as shown in FIG. 5 consists of a section 150 and a display zone 152. Section 150 includes a heading identifying the subject matter of this page 154 (in this case, BILLS). Under the heading, the user is given several choices of various bills associated with his household, including an electric, gas, water, telephone, prescription drugs bill, etc. Any one of these bills may be requested by the user by selecting (i.e., clicking) on the appropriate bill or the symbol disposed above the bill. For esthetic purposes, each available bill may be presented by an appropriately shaped icon, however these icons have been omitted for the sake of simplicity.

Back in FIG. 3, in step 216 the system is waiting for a selection from the user. The selection may be a return which then initiates the loading of the original image 10 (step 202), or the selection of one of the bills, for example, the electrical bill.

When the user selects the electrical bill, in step 220 a decision is made to determine if the requested information is available locally or from a remote location. For the purposes of this discussion, it is assumed that the data for all or at least some of the bills has been entered previously in a data base or other type of program and is available at the device 12. Then, in step 222 the data corresponding to the request from the user is retrieved and displayed in display zone 152 as shown. In the example shown, the amount due on the current bill is shown together with some historical information. Obviously, all this information may be displayed in many formats. On top of section 150, zone 152 of screen 154, a separate section 156 may be reserved and used for advertisements and the like.

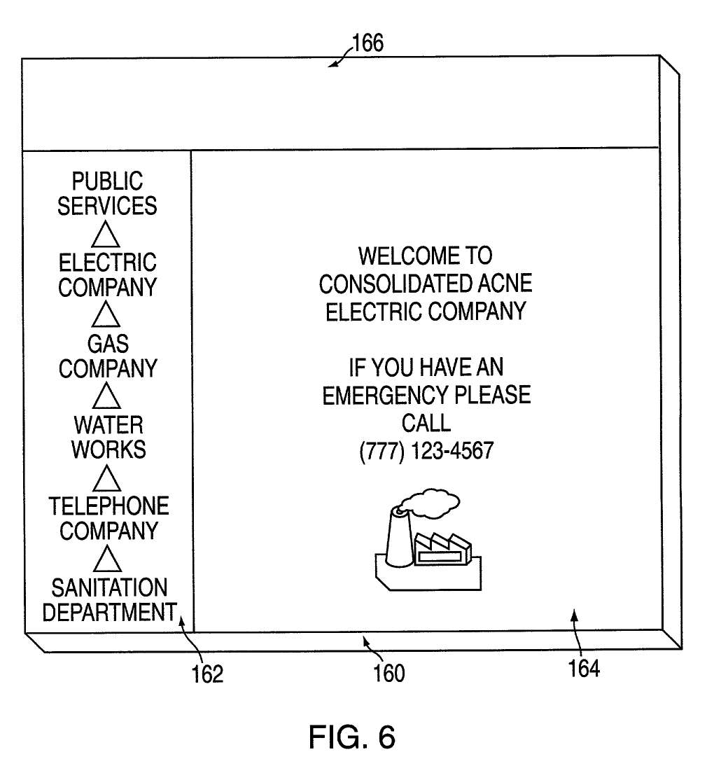

Alternatively, a user may select one of the drawers 54, for example the drawer associated with public service companies. Most if not all information regarding this subject is obtainable from web sites. Therefore, when this drawer is selected in step 212, then a page such as page 160 is displayed as shown in FIG. 6 which also has three a section 162, a display zone 164 and another section 166. Section 162 indicates various choices available under this heading, such as a link to the electrical, gas, telephone company, the water works or the sanitation department. All of these choices represent web sites which are identified by their URL addresses stored as discussed below, and can be retrieved over the Internet in a standard manner.

When the user selects one of these choices, for example, if a user chooses in step 216 the electrical company, then in step 224 the URL of this company is retrieved. In step 226 the URL is provided to the browser. The browser uses this data to find and download the designated webpage(s) in step 228. Once it is downloaded, the information is displayed in zone 164. Again, section 166 is reserved for identifying the source of the program, and other identifying or commercial message. Moreover, for a friendlier and easy to use system, the various public services can be identified by icons on FIG. 6.

The screen 10 shown in FIG. 1 can be generic to many users. Each user can make the screen his home page and use to obtain the information he requires. If a generic version of the screen is used, many of the user-specific image elements, such as the calendar 40, the pencils 52 are inactive and may be omitted.

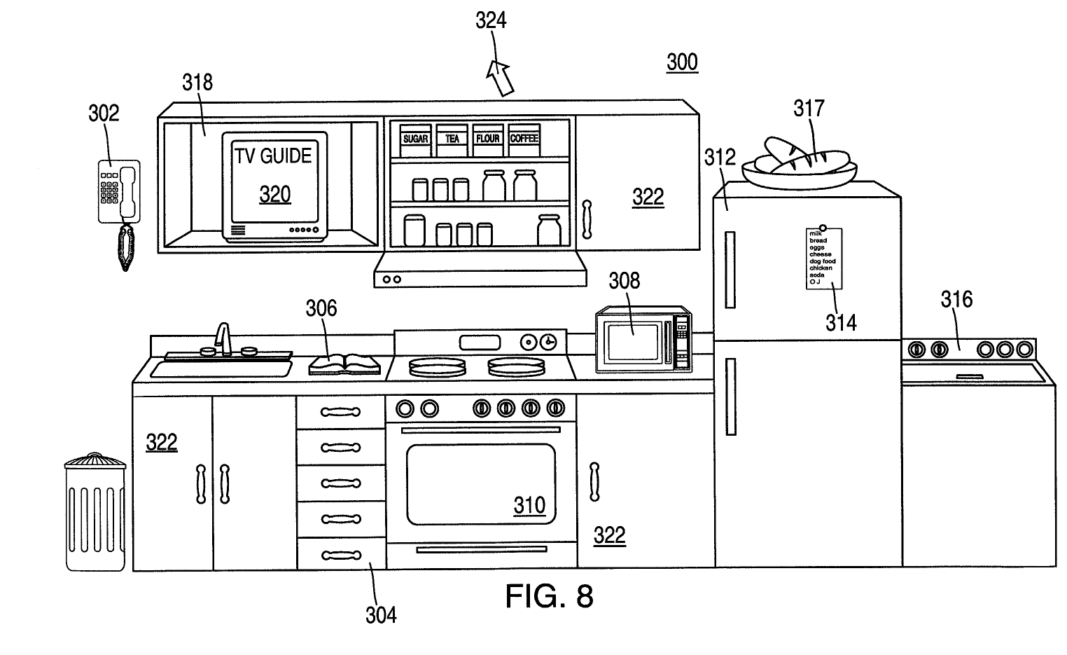

Alternatively, the screen 10 can be customized to the requirements of each user by following a sign up/initialization process which is triggered by selecting the keys 48. Once the site is customized, a specific user can use the system to store his specific data, including bill payment, contact lists, lists of subscribed periodicals, etc. on the memory 22 of PC 12. However, it is even more effective if some or all of this information is stored on line. More specifically, the screen 12 puts the user in contact with a server 170 shown in FIG. 7.

Server 170 includes a user interface 172 through which the server can be contacted by various registered and unregistered users. Server 170 also includes an Internet interface 174 through which the server 170 can connect any user to any web site on the Internet 176. (The interfaces 172 and 174 can be implemented as a single interface, however are shown here as separate elements for the sake of clarity).

Server 170 further includes a data base 178. In this data base 178 a plurality of URL addresses are maintained. These addresses identify web sites specifically identified as meeting certain criteria to insure that the users of the system can receive up to date, reliable and accurate information and prompt services. These web site are selected based on their ability to provide information to the users, and other secure services such ordering goods, trading commodities, obtaining user specific information, paying bills, taxes, make donations, etc. The user-specific information for these transactions, as well as other information required for the device 12 to act as a personal data assistant is stored in memory 180 and is accessible to the respective user only by through a handshaking routine including a user name and a password, as discussed above.

As discussed above, an important feature of the invention is to provide a method and system which provides a friendly, intuitive, easy to use Internet interface, This is accomplished by using the image of a common and familiar environment having a plurality of elements associated with the storage of information, documents or objects. By using an image of a familiar environment, the users are encouraged psychologically to try the interface and to be less afraid the associated technology. In FIGS. 1 and 4A, 4B and 4C the environment depicted is a home office with a desk having drawers and various other objects disposed on its top. FIG. 1 also shows a hutch with various objects disposed on its shelves. Images of other environments may be used as well. For example, FIG. 8 shows an image 300 depicting a kitchen 300 with image elements corresponding to a telephone 302, drawers 304, a recipe book 306, a microwave oven 308, a regular oven 310, a refrigerator 312 with a grocery list 314, a washing machine 316, a bread basket 317, a shelf 318 with a tv set 320 and a plurality of doors 322. By using pointer 324, a user can select any of these image elements and by activating another page similar to the pages shown in FIGS. 5 and 6, he can either provide and store information, access information, or can cause other actions to occur. For example, by selecting the telephone image 302, the user can make a telephone call. By selecting the tv set 320 he can obtain tv listing information. By selecting the recipe book, he can obtain recipes from either a local data base stored in memory 22, or can download recipes over the Internet. He may contact or obtain information about a local bakery by accessing the bread basket 317. Other information may be available by selecting the drawers 304 or doors 322.

Moreover, some of the appliances, such as the regular oven 310, microwave oven 308, refrigerator 312 or washing machine 316 may be remotely controllable. By selecting these images, the user is able to control these devices, i.e., turned them on or off, as desired. For this purpose, when the user selects the images corresponding to one of these devices, another page is generated (not shown) which allows the user to request a command to be sent to the remote device to turn the device on, or off, or to perform any other requited function.

When a user installs the software required to generate the images and associated program described herein, he receives with his installation instructions, a set of choices as well which allows him to designate or assign what image elements he wants in each image, and what is the purpose of each of the image element. In this manner the system is very easy to customize to meet the requirements of the each user. For example, the purpose and function of the drawers 34 in FIG. 1 may be customized by the user. The image elements on the shelves may be selected by a user to match with his personal interests and preferences. All the image elements shown can be omitted and other image elements may be used. Of course, standard images with preselected image elements may also be provided for users who do not want to make their own selections.

In the description above, information may be provided and retrieved, and in general data exchange is provided between an Internet access device, such as the PC 12, and other devices and data banks at remote locations, preferably through the Internet. However, in many instances, Internet access may be down, or it may not be available. Moreover, it should be understood that in many situations, or the data exchange may be performed locally, without the need for connection to or data exchange with the Internet.

Obviously numerous modifications may be made to the invention without departing from its scope as defined in the attached claims.

We claim:

1. A system adapted to provide data exchange or access for a user, said system comprising:
a data access device having a pointing device; and
a screen coupled to said data access device and arranged to display an image of a user familiar environment, said user familiar environment formed of a plurality of objects, each object being suggestive of a category of information, said image having image elements corresponding to said objects, said data access device being adapted to obtain information corresponding to one of said objects when said pointing device points to the image element corresponding said one object.

2. The system of claim 1 wherein said image includes a display area, and wherein said data access device is adapted to show a message in said display area.

3. The system of claim 1 wherein said data access device is adapted to show a message in said display area, said message identifying the information associated with a particular image element.

4. The system of claim 1 wherein one of said image elements is a moving image element.

5. The system of claim 4 wherein said one image element is set into motion when selected by said pointing device.

6. The system of claim 5 wherein said one image element is adapted to show a display area for messages.

7. The system of claim 6 wherein said display element becomes visible when said one image element is selected by said pointing device.

8. The system of claim 1 further comprising an Internet connection and wherein said data access device is coupled to said Internet connection and is adapted to provide data exchange through said Internet connection with other locations.

9. The system of claim 1 wherein in response to a command selection, said data access device is adapted to generate commands to control remote devices.

10. A method of providing information to a user on a data access device, said method comprising:
generating an image on said data access device of a user familiar environment composed of image elements, said user familiar environment being composed of objects associated with information, each of said image elements corresponding to one of said objects to suggest to the user access to corresponding information;
selecting one of said image elements by the user;
retrieving information by said data access device;
providing information associated with the selected one image element.

11. The method of claim 10 further comprising generating messages on said screen.

12. The method of claim 10 further comprising generating messages identifying the information associated with said image elements.

13. The method of claim 8 further comprising activating said one image element to generate a moving picture.

14. The method of claim 13 further comprising activating said one image element with said pointing device.

15. The method of claim 14 further comprising generating a message when said one image element is selected by said pointing device.

16. The method of claim 15 wherein said message identifies information associated with said one image element.

17. The method of claim 13 wherein said moving image corresponds to the motion of the respective object represented by the one image element.

18. The method of claim 17 further comprising generating sounds associated with the motion of the respective object.

19. The method of claim 10 further comprising generating a second image in response to the selection of said one image element.

20. The method of claim 19 wherein the information corresponding to said one image element includes several categories, said second image includes a plurality of indicia corresponding to said categories.

21. The method of claim 20 wherein said categories include generic categories associated with any user and user-specific categories associated with specific users.

22. The method of claim 20 wherein said information is provided when one of said indicia is selected.

23. The method of claim 20 wherein said indicia includes text descriptive of a corresponding category.

24. The method of claim 20 wherein said second image includes a display zone, the information being shown in said display zone.

25. The method of claim 10 wherein said data access device is associated with an Internet connection, further comprising access information over the Internet and downloading said information for display to the user.

26. The method of claim 10 further comprising generating commands in response to a command selection, said commands being operative to activate a remote device.

27. A user friendly Internet interface comprising:
a web browser;
a software that generates for the user an image of a friendly environment formed of objects and composed of image elements, each image element corresponding to one of said objects, said image elements being selectable by the user to obtain information; and
a data base of URL addresses and accessible to said web browser in association with the selection of one of said image elements.

28. The interface of claim 27 wherein said software is adapted to generate a second image in response to a selection of one of said image elements, said second image including a plurality of indicia, each indicia identifying a category of the information associated with said one image element.

29. The interface of claim 27 wherein each of said indicia is associated with at least one of said URL addresses.

30. The interface of claim 27 wherein said second image includes a display zone, wherein the information is provided in said display zone.

31. The interface of claim 27 wherein said data base is stored by a remote data server.
